(19) United States
(12) Patent Application Publication
(10) Pub. No.: US 2022/0098108 A1
(43) Pub. Date: Mar. 31, 2022

(54) GYPSUM BOARD MADE USING DRY STARCH AT AN INTERFACE BETWEEN THE GYPSUM SLURRY AND A FACING MATERIAL

(71) Applicant: Gold Bond Building Products, LLC, Charlotte, NC (US)

(72) Inventors: Mark D. Young, Huntington Beach, CA (US); Courtney D. Holzer, Long Beach, CA (US); Gene A. Whittington, Fort Mill, SC (US)

(21) Appl. No.: 17/487,204

(22) Filed: Sep. 28, 2021

Related U.S. Application Data
(60) Provisional application No. 63/084,038, filed on Sep. 28, 2020.

(51) Int. Cl. C04B 28/14; C04B 24/38

(52) U.S. Cl. CPC C04B 28/14; C04B 2111/0062; C04B 24/38

(57) ABSTRACT

The present invention is directed to an improved gypsum board and a method of making such gypsum board. For instance, the method comprises: providing a first facing material, depositing a gypsum slurry comprising at least stucco and water on the first facing material, providing a second facing material on the gypsum slurry, and allowing the stucco to convert to calcium sulfate dihydrate, wherein the method further comprises a step of providing a dry starch layer including a dry starch at an interface between the first facing material and the gypsum slurry, the second facing material and the gypsum slurry, or both.

### CROSS-REFERENCE TO RELATED APPLICATION

The present application claims filing benefit of U.S. Provisional Patent Application Ser. No. 63/084,038 having a filing date of Sep. 28, 2020, and which is incorporated herein by reference in its entirety.

### BACKGROUND

A building is typically constructed with walls having a frame comprising vertically oriented studs connected by horizontally oriented top and bottom plates or tracks. The walls often include one or more gypsum boards fastened to the studs and/or plates on each side of the frame or, particularly for exterior walls, one or more gypsum boards fastened to the studs and/or plates on one side of the frame with a non-gypsum based sheathing attached to an exterior side of the frame. A ceiling of the building may also include one or more gypsum boards oriented horizontally and fastened to joists, studs, or other structural members extending horizontally in the building. These gypsum boards typically include a gypsum core and facing materials on the major surfaces. The facing materials provide a relatively smooth surface generally for aesthetic purposes. In this regard, it is desired for the facing materials to properly adhere to the gypsum core. One problem with certain current methods is delamination of the facing material from the gypsum core due to insufficient adhesion. To address such problem, various additives may be provided to the gypsum core to assist in the adhesion. However, the use of such additives may also be inadequate, add significant costs to production, and/or such additives may have to be utilized in significant amounts to provide the necessary adhesion.

As a result, there is still a need to further improve the adhesion at the interface between a facing material and a gypsum core.

### SUMMARY OF THE INVENTION

In accordance with one embodiment of the present invention, a method of forming a gypsum board is disclosed. The method comprises: providing a first facing material, depositing a gypsum slurry comprising stucco, starch, and water on the first facing material, providing a second facing material on the gypsum slurry, and allowing the stucco to convert to calcium sulfate dihydrate, wherein the method further comprises a step of providing a dry starch layer including a dry starch at an interface between the first facing material and the gypsum slurry, the second facing material and the gypsum slurry, or both.

In accordance with another embodiment of the present invention, a gypsum board is disclosed. The gypsum board is formed by the following method: providing a first facing material, depositing a gypsum slurry comprising stucco, starch, and water on the first facing material, providing a second facing material on the gypsum slurry, and allowing the stucco to convert to calcium sulfate dihydrate, wherein the method further comprises a step of providing a dry starch layer including a dry starch at an interface between the first facing material and the gypsum slurry, the second facing material and the gypsum slurry, or both.

In accordance with another embodiment of the present invention, a method of forming a gypsum board is disclosed. The method comprises: providing a first facing material, depositing a gypsum slurry comprising stucco and water on the first facing material, providing a second facing material on the gypsum slurry, and allowing the stucco to convert to calcium sulfate dihydrate, wherein the method further comprises a step of providing a dry starch layer including a dry starch at an interface between the first facing material and the gypsum slurry, the second facing material and the gypsum slurry, or both.

In accordance with another embodiment of the present invention, a gypsum board is disclosed. The gypsum board is formed by the following method: providing a first facing material, depositing a gypsum slurry comprising stucco and water on the first facing material, providing a second facing material on the gypsum slurry, and allowing the stucco to convert to calcium sulfate dihydrate, wherein the method further comprises a step of providing a dry starch layer including a dry starch at an interface between the first facing material and the gypsum slurry, the second facing material and the gypsum slurry, or both.

### DETAILED DESCRIPTION

Reference now will be made in detail to various embodiments. Each example is provided by way of explanation of the embodiments, not as a limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Generally speaking, the present invention is directed to a gypsum board and a method of making such gypsum board. In particular, the present invention is directed to the application of a dry starch at an interface of a facing material and the gypsum core. In this regard, the dry starch may be present between the facing material and the gypsum core. The present inventors have discovered that various benefits may be realized by providing a dry starch layer in such a manner.

For instance, improvements in the adhesion of the facing material and the gypsum board may be realized. As a result, such improvements may also result in improvements in the mechanical properties, such as nail pull strength and facing material to gypsum core bond strength, of the gypsum board. In addition, providing a dry starch layer may also allow for a reduction in the amount of starch provided within the gypsum slurry and gypsum core. In turn, as a result of requiring less migration time, the utilization of the dry starch layer as described herein may simplify and make more efficient the manufacturing process.

In general, the present invention is directed to a gypsum board and a method of making such gypsum board. For instance, in the method of making a gypsum board, a first facing material may be provided wherein the first facing material has a first facing material surface and a second facing material surface opposite the first facing material surface. The first facing material may be conveyed on a conveyor system (i.e., a continuous system for continuous manufacture of gypsum board). Thereafter, a gypsum slurry may be provided or deposited on the first facing material in order to form and provide a gypsum core. Next, a second facing material may be provided on the gypsum core.

As indicated herein, the invention is directed to the use of a dry starch for forming a dry starch layer at an interface between a facing material and the gypsum slurry or gypsum core. In one embodiment, the dry starch layer may be provided at the interface between the first facing material and the gypsum slurry or gypsum core. In another embodiment, the dry starch layer may be provided at the interface between the second facing material and the gypsum slurry or gypsum core. In an even further embodiment, the dry starch layer may be provided at the interface between both the first and second facing materials and the gypsum slurry or gypsum core.

When the dry starch layer is provided at the interface between the first facing material and the gypsum slurry or gypsum core, dry starch may be provided on the first facing material surface. For instance, the dry starch may be provided on the first facing material surface offline such that it is already provided on the first facing material prior to use in the manufacture of the gypsum board. Alternatively, or in addition, the dry starch may be provided inline during the manufacture of the gypsum board. In this regard, in one embodiment, the dry starch may already be provided on the facing material prior to deposition of the gypsum slurry. Then, as indicated above, the gypsum slurry is provided or deposited. In this regard, the method may comprise a step of depositing a gypsum slurry onto the first facing material, in particular the dry starch layer formed from the dry starch on the first facing material.

In addition, when the dry starch layer is provided at the interface between the second facing material and the gypsum slurry or gypsum core, the dry starch may be provided in a variety of different manners. For instance, the dry starch may be provided onto the gypsum slurry and gypsum core prior to deposition of the second facing material. When the gypsum core includes a first gypsum layer and a second gypsum layer as defined below, the dry starch and layer may be between the second gypsum layer and the second facing material. When the gypsum core includes a first gypsum layer, a second gypsum layer, and a third gypsum layer as defined below, the dry starch and layer may be between the third gypsum layer and the second facing material.

Alternatively or in addition, like with the first facing material and the starch, it should be understood that the dry starch may be provided offline or online with respect to the second facing material. For instance, the dry starch may be provided on the second facing material surface offline such that it is already provided on the second facing material prior to use in the manufacture of the gypsum board. In this regard, when providing the second facing material on the gypsum slurry, the dry starch and layer will also automatically be provided between the gypsum layer and the second facing material. Alternatively, or in addition, the dry starch may be provided inline during the manufacture of the gypsum board.

When providing the dry starch, it may be applied using means known in the art. These may include rollers, spreaders, sprayers, dusters, etc. The dry starch may be applied to form a continuous layer, to form a pattern, or in a random manner. For example, the pattern may be a grid pattern. In addition, it should be understood that the pattern may be a regular pattern or an irregular pattern. Furthermore, by forming a pattern or applying the dry starch in a random manner, such application may result in a discontinuous dry starch layer.

In this regard, when disposed, the dry starch may partially or entirely cover the respective surface or layer on which it is disposed or positioned. In one embodiment, the dry starch covers the entire surface or layer. In another embodiment, the dry starch only partially covers the entire surface or layer. In this regard, the dry starch may be provided such that it covers 0.1% or more, such as 0.5% or more, such as 1% or more, such as 2% or more, such as 5% or more, such as 10% or more, such as 15% or more, such as 20% or more, such as 25% or more, such as 30% or more, such as 40% or more, such as 50% or more, such as 60% or more of the surface area of the surface or layer on which it is provided. The dry starch may be provided such that it covers 100% or less, such as 99% or less, such as 98% or less, such as 95% or less, such as 90% or less, such as 80% or less, such as 70% or less, such as 60% or less, such as 50% or less, such as 40% or less, such as 30% or less, such as 25% or less, such as 20% or less, such as 15% or less, such as 10% or less of the surface area of the surface or layer on which it is provided.

As indicated herein, the dry starch refers to a starch that is not provided as a solution or dispersion. In this regard, the dry starch layer is not provided in the form of an adhesive or glue such that drying may be required in order to form the dry starch layer. Instead, the dry starch may be provided in a dry form, such as a solid form. As one example, the dry starch may be provided in a powder form. In this regard, the dry starch as applied may contain 15 wt. % or less, such as 13 wt. % or less, such as 10 wt. % or less, such as 9 wt. % or less, such as 8 wt. % or less, such as 7 wt. % or less, such as 6 wt. % or less, such as 5 wt. % or less, such as 4 wt. % or less, such as 3 wt. % or less, such as 2 wt. % or less, such as 1 wt. % or less, such as 0.5 wt. % or less, such as 0.2 wt. % or less, such as 0.1 wt. % or less of a liquid, such as water. For the sake of clarity, when depositing or applying the dry starch, such deposition or application may contain 5 wt. % or less, such as 4 wt. % or less, such as 3 wt. % or less, such as 2 wt. % or less, such as 1 wt. % or less, such as 0.5 wt. % or less, such as 0.2 wt. % or less, such as 0.1 wt. % or less of a liquid, such as water, based on the weight of the dry starch.

In general, the dry starch may be any dry starch that can provide adhesion between the facing material and the gypsum core. In one embodiment, the dry starch may be a migrating starch such that it migrates. In general, these starches refer to those that may migrate when employed within the gypsum slurry and core. As an example, these may migrate to an interface of a facing material and the gypsum core. Alternatively, the dry starch may be a non-migrating starch. In addition, the dry starch may be a mixture of a migrating starch and a non-migrating starch.

Also, the dry starch may be any as known in the art. In general, starch is a polysaccharide carbohydrate that includes a large number of glucose monosaccharide units joined together by glycosidic bonds. Generally, starch can be found in plants and seeds. In this regard, the dry starch may be a corn starch, a wheat starch, a milo starch, a potato starch, a rice starch, an oat starch, a barley starch, a cassava starch, a tapioca starch, a pea starch, a rye starch, an amaranth starch, or other commercially available starch. For example. In one embodiment, the dry starch may be a corn starch. In another embodiment, the dry starch may be a wheat starch. In an even further embodiment, the dry starch may be a milo starch.

Furthermore, the dry starch may be an unmodified starch or a modified starch. In one embodiment, the dry starch may be a modified starch. In another embodiment, the starch may be an unmodified starch. In an even further embodiment, the dry starch may be a mixture of a modified starch and an unmodified starch.

As indicated above, in one embodiment, the starch may be an unmodified starch. For instance, the starch may be a pearl starch (e.g., an unmodified corn starch). In addition, in one embodiment, the starch may also be a non-migrating starch. Also, with respect to gelatinization, the starch may be a non-pregelatinized starch.

As also indicated above, in another embodiment, the starch may be a modified starch. Such modification may be any as typically known in the art and is not necessarily limited. For instance, the modification may be via a physical, enzymatic, or chemical treatment. In one embodiment, the modification may be via a physical treatment. In another embodiment, the modification may be via an enzymatic treatment. In a further embodiment, the modification may be via a chemical treatment. The starch may be treated using many types of reagents. For example, the modification can be conducted using various chemicals, such as inorganic acids (e.g., hydrochloric acid, phosphorous acid or salts thereof, etc.), peroxides (e.g., sodium peroxide, potassium peroxide, hydrogen peroxide, etc.), anhydrides (e.g., acetic anhydride), etc. to break down the starch molecule.

In this regard, in one embodiment, the starch may be a pregelatinized starch, an acid-modified (or hydrolyzed) starch, an extruded starch, an oxidized starch, an oxyhydrolyzed starch, an ethoxylated starch, an ethylated starch, an acetylated starch, a mixture thereof, etc. For example, in one embodiment, the starch may be a pregelatinized starch. In another embodiment, the starch may be an acid-modified (or hydrolyzed) starch. In a further embodiment, the starch may be an extruded search. In another embodiment, the starch may be an oxidized starch. In a further embodiment, the starch may be an oxyhydrolyzed starch. In another further embodiment, the starch may be an ethoxylated starch. In another embodiment, the starch may be an ethylated starch. In a further embodiment, the starch may be an acetylated starch.

In one embodiment, the starch may be a pregelatinized starch. In this regard, the starch may have been exposed to water and heat for breaking down a certain degree of intermolecular bonds within the starch. As an example and without intending to be limited by theory, during heating, water is absorbed into the amorphous regions of the starch thereby allowing it to swell. Then amylose chains may begin to dissolve resulting in a decrease in the crystallinity and an increase in the amorphous form of the starch.

In another embodiment, the starch may be an acid-modified starch. Such acid modification can be conducted using various chemicals, such as inorganic acids (e.g., hydrochloric acid, phosphorous acid or salts thereof, etc.) to break down the starch molecule. Furthermore, by utilizing acid-modification, the starch may result in a low thinned starch, a medium thinned starch, or a high thinned starch. For example, a higher degree of modification can result in a lower viscosity starch while a lower degree of modification can result in a higher viscosity starch. The degree of modification and resulting viscosity may also affect the degree of migration of the starch. For instance, when presented within the core of the gypsum board, a higher degree of modification and lower viscosity may provide a high migrating starch while a lower degree of modification and higher viscosity may provide a low migrating starch.

The starch may also have a particular gelling temperature. Without intending to be limited, this temperature is the point at which the intermolecular bonds of the starch are broken down in the presence of water and heat allowing the hydrogen bonding sites to engage more water. In this regard, the gelling temperature may be 60° C. or more, such as 80° C. or more, such as 100° C. or more, such as 120° C. or more, such as 140° C. or more, such as 160° C. or more, such as 180° C. or more. The gelling temperature may be 300° C. or less, such as 260° C. or less, such as 220° C. or less, such as 200° C. or less, such as 180° C. or less, such as 160° C. or less, such as 140° C. or less, such as 120° C. or less, such as 100° C. or less, such as 80° C. or less. In one embodiment, the aforementioned may refer to a peak gelling temperature.

As indicated above, the starch may have a particular gelling temperature. Without intending to be limited by theory, acid modification may provide a starch having a relatively higher gelling temperature. Meanwhile, without intending to be limited by theory, modifications of the hydroxyl group, such as by replacement via ethoxylation, ethylation, or acetylation may provide a relatively lower gelling temperature or a reduction in gelling temperature. In this regard, in some embodiments, the starch may be acid-modified and chemically modified wherein the hydroxyl groups are substituted.

In one embodiment, the starch may be an extruded starch. For example, the extrusion may provide a thermomechanical process that can break the intermolecular bonds of the starch. Such extrusion may result in the gelatinization of starch due to an increase in the water absorption.

In another embodiment, the starch may be an oxidized starch. For example, the starch may be oxidized using various means known in the art. This may include, but is not limited to, chemical treatments utilizing oxidizing agents such as chlorites, chlorates, perchlorates, hypochlorites (e.g., sodium hypochlorite, etc.), peroxides (e.g., sodium peroxide, potassium peroxide, hydrogen peroxide, etc.), etc. In general, during oxidation, the molecules are broken down yielding a starch with a decreased molecular weight and a reduction in viscosity.

Also, it should be understood that the starch may include a combination of starches, such as any of those mentioned above. For instance, it should be understood that the dry starch may include more than one different starch. For instance, in one embodiment, at least two different dry starches may be provided onto the first facing material. In addition, any combination of modifications may also be utilized to form the dry starch utilized according to the present invention.

Also, the dry starch may be provided or deposited in conjunction with other dry materials or additives that may provide additional benefits at the interface for the gypsum board. For instance, these additives may be utilized in amounts to obtain the desired properties. For instance, these additives, alone or in combination, may be present in an amount of 0.001 lbs/MSF or more, such as 0.01 lbs/MSF or more, such as 0.05 lbs/MSF or more, such as 0.1 lbs/MSF or more, such as 0.2 lbs/MSF or more, such as 0.25 lbs/MSF or more, such as 0.5 lbs/MSF or more, such as 0.75 lbs/MSF or more, such as 1 lb/MSF or more, such as 1.5 lbs/MSF or more, such as 2 lbs/MSF or more, such as 2.5 lbs/MSF or more, such as 3 lbs/MSF or more, such as 4 lbs/MSF or more. These additives, alone or in combination, may be present in an amount of 150 lbs/MSF or less, such as 100 lbs/MSF or less, such as 50 lbs/MSF or less, such as 25 lbs/MSF or less, such as 15 lbs/MSF or less, such as 10 lbs/MSF or less, such as 5 lbs/MSF or less, such as 4 lbs/MSF or less, such as 3 lbs/MSF or less, such as 2.5 lbs/MSF or less, such as 2 lbs/MSF or less, such as 1.5 lbs/MSF or less, such as 1 lbs/MSF or less. Such MSF value may be the weight of the gypsum board in one embodiment. In another embodiment, such MSF value may be the weight of the gypsum within the gypsum core.

As indicated above, the dry starch layer includes the dry starch and may include other additives. Regardless, the dry starch layer may include the dry starch in an amount of 50 wt. % or more, such as 60 wt. % or more, such as 70 wt. % or more, such as 75 wt. % or more, such as 80 wt. % or more, such as 85 wt. % or more, such as 90 wt. % or more, such as 95 wt. % or more. dry starch may be present in an amount of 100 wt. % or less, such as 99.5 wt. % or less, such as 99 wt. % or less, such as 98.5 wt. % or less, such as 98 wt. % or less, such as 97.5 wt. % or less, such as 95 wt. % or less, such as 93 wt. % or less, such as 90 wt. % or less. In this regard, the dry starch layer may include any of the aforementioned additives, alone or in combination, in an amount of 50 wt. % or less, such as 40 wt. % or less, such as 30 wt. % or less, such as 25 wt. % or less, such as 20 wt. % or less, such as 15 wt. % or less, such as 10 wt. % or less, such as 8 wt. % or less, such as 6 wt. % or less, such as 5 wt. % or less, such as 4 wt. % or less, such as 3 wt. % or less, such as 2 wt. % or less, such as 1 wt. % or less. When such additives are utilized, they may be present, alone or in combination, in such layer in an amount of 0.001 wt. % or more, such as 0.01 wt. % or more, such as 0.1 wt. % or more, such as 0.2 wt. % or more, such as 0.4 wt. % or more, such as 0.5 wt. % or more, such as 1 wt. % or more, such as 1.5 wt. % or more, such as 2 wt. % or more, such as 2.5 wt. % or more, such as 3 wt. % or more, such as 5 wt. % or more, such as 8 wt. % or more, such as 10 wt. % or more.

Also, the dry starch within the dry starch layer may be present in an amount of 0.001 lbs/MSF or more, such as 0.01 lbs/MSF or more, such as 0.05 lbs/MSF or more, such as 0.1 lbs/MSF or more, such as 0.2 lbs/MSF or more, such as 0.25 lbs/MSF or more, such as 0.5 lbs/MSF or more, such as 0.75 lbs/MSF or more, such as 1 lb/MSF or more, such as 1.5 lbs/MSF or more, such as 2 lbs/MSF or more, such as 2.5 lbs/MSF or more, such as 3 lbs/MSF or more, such as 4 lbs/MSF or more. The dry starch may be present in an amount of 150 lbs/MSF or less, such as 100 lbs/MSF or less, such as 50 lbs/MSF or less, such as 25 lbs/MSF or less, such as 15 lbs/MSF or less, such as 10 lbs/MSF or less, such as 5 lbs/MSF or less, such as 4 lbs/MSF or less, such as 3 lbs/MSF or less, such as 2.5 lbs/MSF or less, such as 2 lbs/MSF or less, such as 1.5 lbs/MSF or less, such as 1 lbs/MSF or less. Such MSF value may be the weight of the gypsum board in one embodiment. In another embodiment, such MSF value may be the weight of the gypsum within the gypsum core.

In general, the composition of the gypsum slurry and gypsum core is not necessarily limited and may be any generally known in the art. Generally, in one embodiment, the gypsum core is made from a gypsum slurry including at least stucco and water. In this regard, the method may also include a step of combining stucco, water, and any other optional additives as mentioned herein.

In general, stucco may be referred to as calcined gypsum or calcium sulfate hemihydrate. The calcined gypsum may be from a natural source or a synthetic source and is thus not necessarily limited by the present invention. In addition to the stucco, the gypsum slurry may also contain some calcium sulfate dihydrate or calcium sulfate anhydrite. If calcium sulfate dihydrate is present, the hemihydrate is present in an amount of at least 50 wt. %, such as at least 60 wt. %, such as at least 70 wt. %, such as at least 80 wt. %, such as at least 85 wt. %, such as at least 90 wt. %, such as at least 95 wt. %, such as at least 98 wt. %, such as at least 99 wt. % based on the weight of the calcium sulfate hemihydrate and the calcium sulfate dihydrate. Furthermore, the calcined gypsum may be α-hemihydrate, β-hemihydrate, or a mixture thereof.

In addition to the stucco, the gypsum slurry may also contain other hydraulic materials. These hydraulic materials may include calcium sulfate anhydrite, land plaster, cement, fly ash, or any combinations thereof. When present, they may be utilized in an amount of 30 wt. % or less, such as 25 wt. % or less, such as 20 wt. % or less, such as 15 wt. % or less, such as 10 wt. % or less, such as 8 wt. % or less, such as 5 wt. % or less based on the total content of the hydraulic material.

As indicated above, the gypsum slurry may also include water. Water may be employed for fluidity and also for rehydration of the gypsum to allow for setting. The amount of water utilized is not necessarily limited by the present invention.

In addition, the weight ratio of the water to the stucco may be 0.2 or more, such as 0.2 or more, such as 0.3 or more, such as 0.4 or more, such as 0.5 or more. The water to stucco weight ratio may be 4 or less, such as 3.5 or less, such as 3 or less, such as 2.5 or less, such as 2 or less, such as 1.7 or less, such as 1.5 or less, such as 1.4 or less, such as 1.3 or less, such as 1.2 or less, such as 1.1 or less, such as 1 or less, such as 0.9 or less, such as 0.85 or less, such as 0.8 or less, such as 0.75 or less, such as 0.7 or less, such as 0.6 or less, such as 0.5 or less, such as 0.4 or less, such as 0.35 or less, such as 0.3 or less, such as 0.25 or less, such as 0.2 or less.

In one embodiment, the gypsum core and slurry may also include a starch as mentioned above. In one embodiment, the starch utilized in the gypsum slurry and core may be the same as the dry starch utilized in the dry starch layer. In another embodiment, the starch utilized in the gypsum slurry and core may be different from the dry starch utilized in the dry starch layer. For instance, the starch may be provided by mixing the starch directly with the stucco and water to form the gypsum slurry. In addition to the starch, if providing the starch as a formulation or composition, other additives as mentioned above may also be utilized.

As indicated herein, by providing the dry starch at an interface of a facing material and the gypsum slurry and core, the amount of starch utilized within the slurry and core may be reduced. In this regard, when present, starch may be present in the gypsum core in an amount to a provide further improvement in properties to the gypsum board. When making the board, the starch may be present in an amount of 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more based on the weight of the stucco. The starch may be present in an amount of 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.2 wt. % or less based on the weight of the stucco. In one embodiment, however, starch may be present in an amount of about 0 wt. %. The aforementioned weight percentages may also apply based on the weight of the gypsum in the gypsum board. In addition, the aforementioned weight percentages may also apply based on the weight of the gypsum board. Also, the aforementioned weight percentages may also apply based on the solids content of the gypsum slurry.

By utilizing the dry starch layer as disclosed herein, the amount of starch required within the gypsum slurry and core may be reduced. In this regard, in order to provide the same bond strength between a facing material and the gypsum core, the amount of starch utilized within the gypsum slurry and core may be reduced by 5% or more, such as 10% or more, such as 20% or more, such as 30% or more, such as 40% or more, such as 50% or more, such as 60% or more, such as 70% or more, such as 80% or more, such as 90% or more compared to a gypsum board that does not utilize a dry starch layer as disclosed herein. The amount of starch utilized within the gypsum slurry and core may be reduced by 100% or less, such as 95% or less, such as 90% or less, such as 80% or less, such as 70% or less, such as 60% or less, such as 50% or less, such as 40% or less, such as 30% or less, such as 20% or less, such as 10% or less compared to a gypsum board that does not utilize a dry starch layer as disclosed herein. For instance, in one embodiment, the dry starch layer may provide sufficient adhesion that starch may not even need to be utilized within the gypsum slurry and core.

In addition to the stucco and the water, the gypsum slurry may also include any other conventional additives as known in the art. In this regard, such additives are not necessarily limited by the present invention. For instance, the additives may include dispersants, foam or foaming agents including aqueous foam (e.g. sulfates), set accelerators (e.g., BMA, land plaster, sulfate salts, etc.), set retarders, binders, biocides (such as bactericides and/or fungicides), adhesives, pH adjusters, thickeners (e.g., silica fume, Portland cement, fly ash, clay, celluloses, high molecular weight polymers, etc.), leveling agents, non-leveling agents, colorants, fire retardants or additives (e.g., silica, silicates, expandable materials such as vermiculite, perlite, etc.), water repellants, fillers (e.g., glass fibers), waxes, secondary phosphates (e.g., condensed phosphates or orthophosphates including trimetaphosphates, polyphosphates, and/or cyclophosphates, etc.), mixtures thereof, natural and synthetic polymers, etc. In general, it should be understood that the types and amounts of such additives are not necessarily limited by the present invention.

In general, each additive may be present in the gypsum slurry in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more based on the weight of the stucco. The additive may be present in an amount of 20 wt. % or less, such as 15 wt. % or less, 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.2 wt. % or less based on the weight of the stucco. The aforementioned weight percentages may also apply based on the weight of the gypsum in the gypsum board. In addition, the aforementioned weight percentages may also apply based on the weight of the gypsum board. Also, the aforementioned weight percentages may also apply based on the solids content of the gypsum slurry.

The manner in which the components for the gypsum slurry are combined is not necessarily limited. For instance, the gypsum slurry can be made using any method or device generally known in the art. In particular, the components of the slurry can be mixed or combined using any method or device generally known in the art. For instance, the components of the gypsum slurry may be combined in any type of device, such as a mixer and in particular a pin mixer. In this regard, the manner in which the starch is incorporated into the gypsum slurry is not necessarily limited by the present invention. When a starch is provided in the gypsum slurry as well, it may be provided prior to a mixing device, directly into a mixing device, and/or even after the mixing device. For instance, the starch may be provided prior to a mixing device. In another embodiment, the starch may be provided directly into a mixing device. Alternatively, the starch may be provided after the mixing device (such as to the canister or boot, using a secondary mixer, or applied directly onto the slurry after a mixing device) and may be added directly or as part of a mixture. Whether provided prior to, into, or after the mixing device, the starch may be combined directly with another component of the gypsum slurry. In addition, whether providing the starch prior to or after the mixing device or directly into the mixing device, the compound may be delivered as a solid, as a dispersion/solution, or a combination thereof.

In one embodiment, the gypsum core may include a first gypsum layer and a second gypsum layer. The first gypsum layer may be between the first facing material (i.e., front of the board), in particular the dry starch layer on the first facing material, and the second gypsum layer. In addition, the first gypsum layer may have a density greater than the second gypsum layer. Accordingly, the first gypsum layer may be formed using a gypsum slurry without the use of a foaming agent or with a reduced amount of foaming agent, which may be utilized in forming the second gypsum layer. In this regard, in one embodiment, the first gypsum layer may have the same composition as the second gypsum layer except that the second gypsum layer may be formed using a foaming agent or a greater amount of foaming agent.

In one embodiment, the gypsum core may also include a third gypsum layer. The third gypsum layer may be provided between the second gypsum layer and a second facing material. Like the first gypsum layer, the third gypsum layer may also be a dense gypsum layer. In particular, the third gypsum layer may have a density greater than the second gypsum layer. Accordingly, the third gypsum layer may be formed using a gypsum slurry without the use of a foaming agent or with a reduced amount of foaming agent, which may be utilized in forming the second gypsum layer. In this regard, in one embodiment, the third gypsum layer may have the same composition as the second gypsum layer except that the second gypsum layer may be formed using a foaming agent or a greater amount of foaming agent.

Furthermore, when utilized within the gypsum core, the starch may be provided in any of the first gypsum layer, the second gypsum layer, and/or the third gypsum layer. Alternatively, in one embodiment, the starch may be provided in only one of such layers. In another embodiment, the starch may be provided in two of such layers. In a further embodiment, the starch may be provided in all three of the gypsum layers.

In this regard, when the gypsum core includes multiple gypsum layers, the gypsum slurry may be deposited in multiple steps for forming the gypsum core. For instance, each gypsum layer may require a separate deposition of gypsum slurry. In this regard, with a first gypsum layer and a second gypsum layer, a first gypsum slurry may be deposited followed by a second gypsum slurry. The first gypsum slurry and the second gypsum slurry may have the same composition except that the second gypsum slurry may include a foaming agent or more foaming agent than the first gypsum slurry. In this regard, in one embodiment, the first gypsum slurry may not include a foaming agent. Accordingly, the first gypsum slurry may result in a dense gypsum layer, in particular a non-foamed gypsum layer. Such gypsum layer may have a density greater than the gypsum layer formed from the second gypsum slurry, or foamed gypsum layer.

Similarly, when the gypsum core includes three gypsum layers, the gypsum slurry may be deposited in three steps for forming the gypsum core. For example, a first and second gypsum slurry may be deposited as indicated above and a third gypsum slurry may be deposited onto the second gypsum slurry. The third gypsum slurry and the second gypsum slurry may have the same composition except that the second gypsum slurry may include a foaming agent or more foaming agent than the third gypsum slurry. In this regard, in one embodiment, the third gypsum slurry may not include a foaming agent. Accordingly, the third gypsum slurry may result in a dense gypsum layer, in particular a non-foamed gypsum layer. Such gypsum layer may have a density greater than the gypsum layer formed from the second gypsum slurry, or foamed gypsum layer.

The first gypsum layer may have a thickness that is 0.5% or more, such as 1% or more, such as 2% or more, such as 3% or more, such as 4% or more, such as 5% or more, such as 10% or more, such as 15% or more the thickness of the second (or foamed) gypsum layer. The thickness may be 80% or less, such as 60% or less, such as 50% or less, such as 40% or less, such as 30% or less, such as 25% or less, such as 20% or less, such as 15% or less, such as 10% or less, such as 8% or less, such as 5% or less the thickness of the second (or foamed) gypsum layer. In one embodiment, such relationship may also be between the third gypsum layer and the second gypsum layer.

The density of the second (or foamed) gypsum layer may be 0.5% or more, such as 1% or more, such as 2% or more, such as 3% or more, such as 4% or more, such as 5% or more, such as 10% or more, such as 15% or more the density of the first (or non-foamed) gypsum layer. The density of the second (or foamed) gypsum layer may be 80% or less, such as 60% or less, such as 50% or less, such as 40% or less, such as 30% or less, such as 25% or less, such as 20% or less, such as 15% or less, such as 10% or less, such as 8% or less, such as 5% or less the density of the first (or non-foamed) gypsum layer. In one embodiment, such relationship may also be between the third gypsum layer and the second gypsum layer. In addition, in one embodiment, all of the gypsum layers may have a different density.

As indicated herein, the dry starch is provided at an interface between a facing material and the gypsum slurry or gypsum core. The facing material may be any facing material as generally employed in the art. For instance, the facing material may be a paper facing material, a fibrous (e.g., glass fiber) mat facing material, or a polymeric facing material. In general, the first facing material and the second facing material may be the same type of material. Alternatively, the first facing material may be one type of material while the second facing material may be a different type of material.

In one embodiment, the facing material may include a paper facing material. For instance, both the first and second facing materials may be a paper facing material. Alternatively, in another embodiment, the facing material may be a glass mat facing material. For instance, both the first and second facing materials may be a glass mat facing material. In a further embodiment, the facing material may be a polymeric facing material. For instance, both the first and second facing materials may be a polymeric facing material. In another further embodiment, the facing material may be a metal facing material (e.g., an aluminum facing material). For instance, both the first and second facing materials may be a metal facing material (e.g., an aluminum facing material).

After deposition of the stucco (calcined gypsum) slurry, the calcium sulfate hemihydrate reacts with the water to convert the calcium sulfate hemihydrate into a matrix of calcium sulfate dihydrate. Such reaction may allow for the stucco to set and become firm thereby allowing for the boards to be cut at the desired length. In this regard, the method may comprise a step of reacting calcium sulfate hemihydrate with water to form calcium sulfate dihydrate or allowing the calcium sulfate hemihydrate to convert to calcium sulfate dihydrate. In this regard, the method may allow for the slurry to set to form a gypsum board.

The method may also comprise a step of cutting a continuous gypsum sheet into a gypsum board. Then, after the cutting step, the method may comprise a step of supplying the gypsum board to a heating or drying device. For instance, such a heating or drying device may be a kiln and may allow for removal of any free water. The temperature and time required for heating in such heating or drying device are not necessarily limited by the present invention. Also, by providing a dry starch layer at an interface of a facing material and gypsum core as mentioned herein, the gypsum core may be protected by reducing the degree of surface calcination as the gypsum board is heated or dried within the kiln or drying device. For example, because a dry starch layer is provided, the time required for any starch migration within the gypsum core may be reduced thereby reducing the necessary time required within a kiln or heating device. With such reduction in time, the method also may result in a lesser degree of surface calcination during such process. Further, because use of the overall amount of starch may be reduce, the amount of heat required in the kiln or dryer may also be reduced in some instances, for example depending on the type of starch utilized.

The present invention also discloses a gypsum board. The gypsum board includes a gypsum core having a first gypsum layer surface and a second gypsum layer surface opposing the first gypsum layer surface. A dry starch layer may be disposed at a gypsum layer surface. In particular, a first dry starch layer may be disposed at a first gypsum layer surface. In one embodiment, the first dry starch layer may be disposed directly onto the first gypsum layer surface. In another embodiment, the first dry starch layer may be disposed on a facing material disposed on the first gypsum layer surface. In a further embodiment, a second dry starch layer may be disposed on another gypsum layer surface. Such second dry starch layer may be disposed on a facing material disposed on the second gypsum layer surface. In this regard, the gypsum board may include a first facing material, a first dry starch layer, a gypsum core, a second dry starch layer, and a second facing material.

The gypsum board disclosed herein may have many applications. For instance, the gypsum board may be used as a standalone board in construction for the preparation of walls, ceilings, floors, etc. As used in the present disclosure, the term “gypsum board,” generally refers to any panel, sheet, or planar structure, either uniform or formed by connected portions or pieces, that is constructed to at least partially establish one or more physical boundaries. Such existing, installed, or otherwise established or installed wall or ceiling structures comprise materials that may include, as non-limiting examples, gypsum, stone, ceramic, cement, wood, composite, or metal materials. The installed gypsum board forms part of a building structure, such as a wall or ceiling.

The thickness of the gypsum board, and in particular, the gypsum core, is not necessarily limited and may be from about 0.25 inches to about 1 inch. For instance, the thickness may be at least ¼ inches, such as at least 5/16 inches, such as at least ⅜ inches, such as at least ½ inches, such as at least ⅝ inches, such as at least ¾ inches, such as at least 1 inch. In this regard, the thickness may be about any one of the aforementioned values. For instance, the thickness may be about ¼ inches. Alternatively, the thickness may be about ⅜ inches. In another embodiment, the thickness may be about ½ inches. In a further embodiment, the thickness may be about ⅝ inches. In another further embodiment, thickness may be about 1 inch. In addition, at least two gypsum boards may be combined to create another gypsum board. For example, at least two gypsum boards having a thickness of about 5/16 inches each may be combined or sandwiched to create a gypsum board having a thickness of about ⅝ inches. While this is one example, it should be understood that any combination of gypsum boards may be utilized to prepare a sandwiched gypsum board. With regard to the thickness, the term “about” may be defined as within 10%, such as within 5%, such as within 4%, such as within 3%, such as within 2%, such as within 1%.

In addition, the board weight of the gypsum board is not necessarily limited. For instance, the gypsum board may have a board weight of 500 lbs/MSF or more, such as about 600 lbs/MSF or more, such as about 700 lbs/MSF or more, such as about 800 lbs/MSF or more, such as about 900 lbs/MSF or more, such as about 1000 lbs/MSF or more, such as about 1100 lbs/MSF or more, such as about 1200 lbs/MSF or more, such as about 1300 lbs/MSF or more, such as about 1400 lbs/MSF or more, such as about 1500 lbs/MSF or more. The board weight may be about 7000 lbs/MSF or less, such as about 6000 lbs/MSF or less, such as about 5000 lbs/MSF or less, such as about 4000 lbs/MSF or less, such as about 3000 lbs/MSF or less, such as about 2500 lbs/MSF or less, such as about 2000 lbs/MSF or less, such as about 1800 lbs/MSF or less, such as about 1600 lbs/MSF or less, such as about 1500 lbs/MSF or less, such as about 1400 lbs/MSF or less, such as about 1300 lbs/MSF or less, such as about 1200 lbs/MSF or less. Such board weight may be a dry board weight such as after the board leaves the heating or drying device (e.g., kiln).

In addition, the gypsum board may have a density of about 5 pcf or more, such as about 10 pcf or more, such as about 15 pcf or more, such as about 20 pcf or more. The board may have a density of about 60 pcf or less, such as about 50 pcf or less, such as about 40 pcf or less, such as about 35 pcf or less, such as about 33 pcf or less, such as about 30 pcf or less, such as about 28 pcf or less, such as about 25 pcf or less, such as about 23 pcf or less, such as about 20 pcf or less.

The gypsum board may have a certain nail pull resistance, which generally is a measure of the force required to pull a gypsum panel off of a wall by forcing a fastening nail through the panel. The values obtained from the nail pull test generally indicate the maximum stress achieved while the fastener head penetrates through the board surface and core. In this regard, the gypsum board exhibits a nail pull resistance of at least about 25 lb_{f}, such as at least about 30 pounds, such as at least about 35 lb_{f}, such as at least about 40 lb_{f}, such as at least about 45 lb_{f}, such as at least about 50 lb_{f}, such as at least about 55 lb_{f}, such as at least about 60 lb_{f}, such as at least about 65 lb_{f}, such as at least about 70 lb_{f}, such as at least about 75 lb_{f}, such as at least about 77 lb_{f}, such as at least about 80 lb_{f}, such as at least about 85 lb_{f}, such as at least about 90 lb_{f}, such as at least about 95 lb_{f}, such as at least about 100 lb_{f} as tested according to ASTM C1396. The nail pull resistance may be about 150 lb_{f} or less, such as about 140 lb_{f} or less, such as about 130 lb_{f} or less, such as about 120 lb_{f} or less, such as about 110 lb_{f} or less, such as about 105 lb_{f} or less, such as about 100 lb_{f} or less, such as about 95 lb_{f} or less, such as about 90 lb_{f} or less, such as about 85 lb_{f} or less, such as about 80 lb_{f} or less as tested according to ASTM C1396. Such nail pull resistance may be based upon the thickness of the gypsum board. For instance, when conducting a test, such nail pull resistance values may vary depending on the thickness of the gypsum board. As an example, the nail pull resistance values above may be for a ⅝ inch board. However, it should be understood that instead of a ⅝ inch board, such nail pull resistance values may be for any other thickness gypsum board as mentioned herein.

The gypsum board may have a certain compressive strength. For instance, the compressive strength may be about 150 psi or more, such as about 200 psi or more, such as about 250 psi or more, such as about 300 psi or more, such as about 350 psi or more, such as about 375 psi or more, such as about 400 psi or more, such as about 500 psi or more as tested according to ASTM C473. The compressive strength may be about 3000 psi or less, such as about 2500 psi or less, such as about 2000 psi or less, such as about 1700 psi or less, such as about 1500 psi or less, such as about 1300 psi or less, such as about 1100 psi or less, such as about 1000 psi or less, such as about 900 psi or less, such as about 800 psi or less, such as about 700 psi or less, such as about 600 psi or less, such as about 500 psi or less. Such compressive strength may be based upon the density and thickness of the gypsum board. For instance, when conducting a test, such compressive strength values may vary depending on the thickness of the gypsum board. As an example, the compressive strength values above may be for a ⅝ inch board. However, it should be understood that instead of a ⅝ inch board, such compressive strength values may be for any other thickness gypsum board as mentioned herein.

In addition, the gypsum board may have a core hardness of at least about 8 lb_{f}, such as at least about 10 lb_{f}, such as at least about 11 lb_{f}, such as at least about 12 lb_{f}, such as at least about 15 lb_{f}, such as at least about 18 lb_{f}, such as at least about 20 lb_{f} as tested according to ASTM C1396. The gypsum board may have a core hardness of 50 lb_{f} or less, such as about 40 lb_{f} or less, such as about 35 lb_{f} or less, such as about 30 lb_{f} or less, such as about 25 lb_{f} or less, such as about 20 lb_{f} or less, such as about 18 lb_{f} or less, such as about 15 lb_{f} or less as tested according to ASTM C1396. In addition, the gypsum board may have an end hardness according to the aforementioned values. Further, the gypsum board may have an edge hardness according to the aforementioned values. Such core hardness may be based upon the thickness of the gypsum board. For instance, when conducting a test, such core hardness values may vary depending on the thickness of the gypsum board. As an example, the core hardness values above may be for a ⅝ inch board. However, it should be understood that instead of a ⅝ inch board, such core hardness values may be for any other thickness gypsum board as mentioned herein.

While particular embodiments of the present disclosure have been illustrated and described, it would be obvious to those skilled in the art that various other changes and modifications can be made without departing from the spirit and scope of the present disclosure. It is therefore intended to cover in the appended claims all such changes and modifications that are within the scope of this disclosure.

1. A method of forming a gypsum board, the method comprising:
providing a first facing material,
depositing a gypsum slurry comprising stucco, starch, and water on the first facing material,
providing a second facing material on the gypsum slurry, and
allowing the stucco to convert to calcium sulfate dihydrate,
wherein the method further comprises a step of providing a dry starch layer including a dry starch at an interface between the first facing material and the gypsum slurry, the second facing material and the gypsum slurry, or both.

2. The method of claim 1, wherein the method comprises providing a dry starch at an interface between the first facing material and the gypsum slurry.

3. The method of claim 2, wherein the dry starch is provided on a surface of the first facing material adjacent the gypsum slurry such that it covers 0.1% to 100% of the surface area of the surface of the first facing material adjacent the gypsum slurry.

4. The method of claim 1, wherein the method comprises providing a dry starch at an interface between the second facing material and the gypsum slurry.

5. The method of claim 4, wherein the dry starch is provided on a surface of the second facing material adjacent the gypsum slurry such that it covers 0.1% to 100% of the surface area of the surface of the second facing material adjacent the gypsum slurry.

6. The method of claim 4, wherein the dry starch is provided on a surface of the gypsum slurry such that it covers 0.1% to 100% of the surface area of the surface of the gypsum slurry.

7. The method of claim 1, wherein the method comprises providing a dry starch at an interface between the first facing material and the gypsum slurry and at an interface between the first facing material and the gypsum slurry.

8. The method of claim 1, wherein the step of providing a gypsum slurry includes providing a first gypsum slurry and a second gypsum slurry, the first gypsum slurry having a foaming agent in an amount less than the second gypsum slurry.

9. The method of claim 1, wherein the dry starch a corn starch, a wheat starch, a milo starch, a potato starch, a rice starch, an oat starch, a barley starch, a cassava starch, a tapioca starch, a pea starch, a rye starch, an amaranth starch, or a mixture thereof.

10. The method of claim 1, wherein the dry starch comprises a modified starch.

11. The method of claim 10, wherein the modified starch is pregelatinized starch, acid-modified, ethoxylated, ethylated, acetylated, oxidized, or oxyhydrolyzed.

12. The method of claim 1, wherein the dry starch comprises an unmodified starch.

13. The method of claim 1, wherein the dry starch layer includes dry starch in an amount of at least 90 wt. %.

14. The method of claim 1, wherein the dry starch layer is provided with dry starch and 5% or less of a liquid based on the weight of the dry starch.

15. The method of claim 1, wherein the dry starch layer is provided with dry starch and 2% or less of a liquid based on the weight of the dry starch.

16. The method of claim 1, wherein the dry starch is provided as a powder.

17. The method of claim 1, wherein the starch in the gypsum slurry is the same as the dry starch.

18. The method of claim 1, wherein the starch in the gypsum slurry is provided in an amount of 5 wt. % or less based on the weight of the stucco.

19. The method of claim 1, wherein the dry starch is present in an amount of from 0.001 lbs/MSF to 50 lbs/MSF based on the weight of the gypsum board.

20. A gypsum board formed from the method of claim 1.

21. A method of forming a gypsum board, the method comprising:
providing a first facing material,
depositing a gypsum slurry comprising stucco and water on the first facing material,
providing a second facing material on the gypsum slurry, and
allowing the stucco to convert to calcium sulfate dihydrate,
wherein the method further comprises a step of providing a dry starch layer including a dry starch at an interface between the first facing material and the gypsum slurry, the second facing material and the gypsum slurry, or both.

22-41. (canceled)
